(19) United States
(12) Patent Application Publication
(10) Pub. No.: US 2009/0098379 A1
(43) Pub. Date: Apr. 16, 2009

(54) CLOSED-PORE GLASS SOIL ADDITIVES AND A METHOD FOR USING THE SAME

(76) Inventors: W. Gene Ramsey, Las Cruces, NM (US); Andrew Ungerleider, Santa Fe, NM (US)

Correspondence Address: TAFT STETTINIUS & HOLLISTER LLP, ONE INDIANA SQUARE, SUITE 3500, INDIANAPOLIS, IN, 46204, US

(21) Appl. No.: 11/872,946

(22) Filed: Oct. 16, 2007

(51) Int. Cl. B32B 1/00; C03B 19/10

(52) U.S. Cl. 428/402; 65/21.1

(57) ABSTRACT

A granular soil composition consisting of a first mixture of organic material and a second plurality of substantially nonporous generally spherical foamed glass particles. The second substantially nonporous generally spherical foamed glass particles is typically present in amounts of between about 20 and 50 volume percent. The first mixture is typically selected from the group including bark, wood chips, rice husks, coco peat, peat moss and mixtures thereof and the plurality if substantially nonporous generally spherical foamed glass particles are characterized by mean strengths of at least about 350 PSI, diameters of between about 0.1 and 10 millimeters, and bulk densities of between about 15 and about 60 lb/ft³.

### TECHNICAL FIELD

The novel technology relates generally to the materials science, and, more particularly, to a method for using closed pore glass particles or spheres to treat or condition soil.

### BACKGROUND

Soil may be improved through chemical means, such as via the adjustment of pH and the balancing of inorganic nutrients, and/or through physical means, such as via modification of its water permeability, air permeability and water retention properties, and/or through biological means, such as via the rebalancing of ecological systems concerning the activity of useful microorganisms in the soil. Many soil conditioning techniques are known in the art, but they all tend to be most effective at accomplishing one of the aforementioned means while actually detracting from another. For example, the common practice of adding slag or coal ash to soil to increase the pH of acidic soil tends harden the soil. Furthermore, slag and coal ash have the additional disadvantage of having low fertilizer-retaining power, and thus fertilizers added to slag/ash treated soil tend to be carried away by rainwater and/or irrigation.

One method for the physical conditioning of the soil is through the dispersal and mixing of foamed polystyrene particles therein. However, such treatment additives are very lightweight, and tend to rise to the surface during irrigation and wash away, thus decreasing the soil-conditioning effect and, moreover, decreasing the effectiveness of fertilizers, as these also tend to be washed away with the polystyrene particles. Further, foamed polymer conditioning materials are readily crushed during long-term use due to their relatively low compressive strength, and thus suffer from a steadily decreasing volume over time. As a result, the benefit of drainage and aeration is diminished over time. Thus, there remains a need for a physical soil conditioner that does not affect the pH of the soil system and that will not be subject to crushing or washout over time. The present invention addresses this need.

### SUMMARY

The present novel technology relates generally to the use of closed pore glass particles as physical soil conditioning agents. One object of the present novel technology is to provide an improved soil conditioner. Related objects and advantages of the present novel technology will be apparent from the following description.

### BRIEF DESCRIPTION OF THE DRAWINGS

FIG. 1 is a perspective drawing of an individual glass bead used in the soil amendment method according to one embodiment of the present invention.

FIG. 2 is a partial cutaway view of a plant growing in soil amended according to the embodiment of FIG. 1.

FIG. 3 is a partial cutaway view of a plant growing in artificial soil including the soil amendment composition according to the embodiment of FIG. 1.

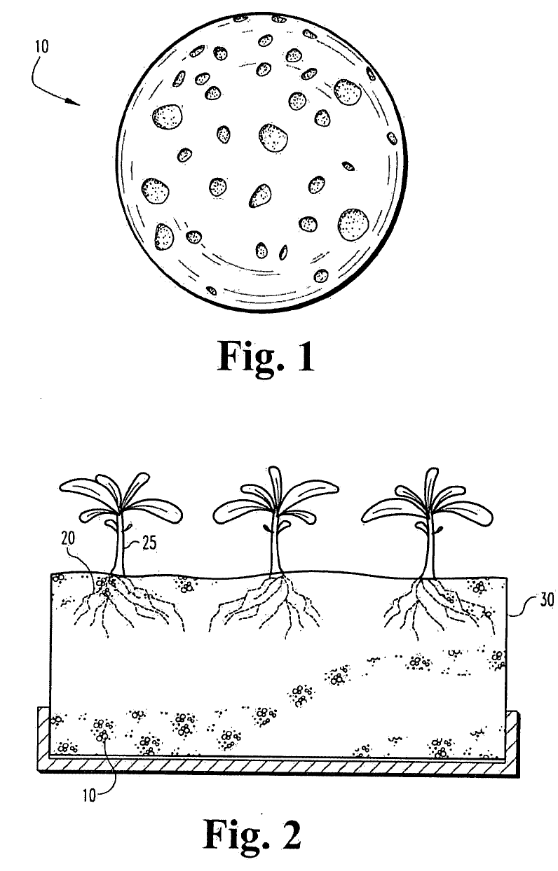

### DETAILED DESCRIPTION OF THE PREFERRED EMBODIMENT

For the purposes of promoting an understanding of the principles of the novel technology, reference will now be made to the embodiments illustrated in the drawings and specific language will be used to describe the same. It will nevertheless be understood that no limitation of the scope of the novel technology is thereby intended, such alterations and further modifications in the illustrated device, and such further applications of the principles of the novel technology as illustrated therein being contemplated as would normally occur to one skilled in the art to which the novel technology relates.

The present invention relates to a method for increasing the water and air permeability of soil, such as very dense soil or soil rich in clay, through the addition of incompressible and inert vitreous particulate additives 10. Typically, these vitreous soil treatment additives have the form of porous glass beads 10 or bodies 10 and are characterized by a substantially closed-cell or closed pore structure. The glass beads 10 are typically between about 0.1 mm and about 10 mm in diameter, but may range from about 0.05 to about 20 mm or more in diameter.

Typically, the glass beads 10 are relatively inert and chemically stable. The glass beads 10 typically do not substantially contribute to a pH shift when added to the soil, nor do they of themselves typically represent a significant source of chemicals, such as through leaching or the like. Typically, the substantially closed pore glass beads 10 have a pH value of between about 9 and about 12. Also typically, the closed pore glass beads 10 have a water absorption value of about 1-2 volume percent.

The glass beads 10 are typically formed from a high silica or soda-lime-silica composition, but may also be of borate, aluminosilicate, or other glass compositions. In addition to silicon, sodium and calcium, the glass compositions may also include such cations as aluminum, boron, titanium, iron, manganese, magnesium, potassium, and the like. In other words, in addition to soda, lime and silica precursors, the typical bead batch compositions and may also include amounts of such precursors as titania, alumina, boria, iron oxide, magnesia, manganese oxide, and the like, as well as carbonates and/or nitrates or these cations.

The beads 10 are typically characterized by a compressive strength of between about 150 PSI (for beads of diameters of between about 8 and about 10 mm) and about 350 PSI (for beads of diameters of between about 0.1 and about 0.2 mm). Certain bead compositions may, of course, yield stronger (or weaker) beads (such as having strengths of around 950 PSI or greater for diameters between about 0.2 and 0.5 mm); likewise, processing parameters such as slow annealing or cooling from the melt may likewise contribute to higher strengths.

The bulk density of the glass beads 10 is typically in the range of between about 5 lb/ft³ and about 35 lb/ft³, and more typically in the range of about 10 lb/ft³ and about 25 lb/ft³. Typically, the smaller the bead, the higher the bulk density value for a given composition. The apparent density of the beads likewise ranges from about 15 lb/ft³ to about 60 lb/ft³, and more typically from about 20 lb/ft³ to about 40 lb/ft³. The glass beads 10 are generally spherical, although the beads may have any convenient regular or irregular shapes.

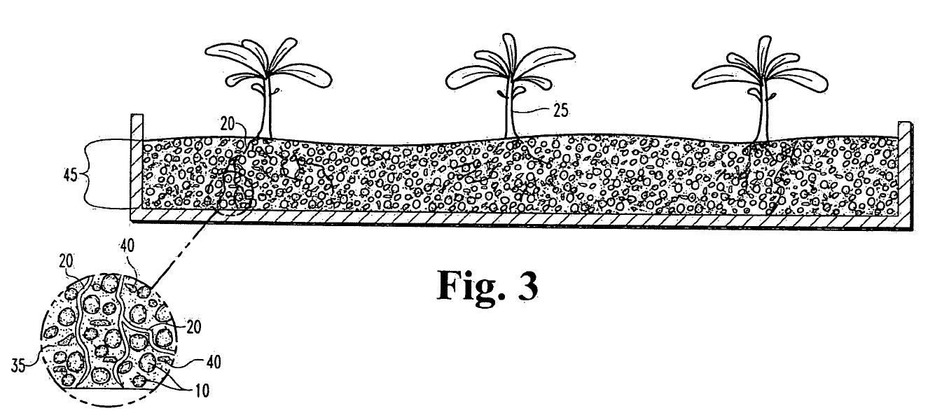

In operation, the beads 10 are mixed with soil 15 to help provide controlled hydration and aeration pathways and to help control the growth of the roots 20 of plants 25 in the amended soil mixture 30. (See FIG. 2). Other materials, such as perlite, rice husks, E-stone, vermiculite, pumice and the like may be added along with the beads 10. The beads 10 may be added to natural soil 15, or may be mixed with sand 35 and/or other organic materials 40 such as peat moss, coco peat, rice husks, mulch, wood chips, bark, leaves, or the like and combinations thereof to yield an artificial soil mixture 45. (See FIG. 3). Typically, between about 5 and about 50 volume percent beads are added to soil 15, more typically between about 20 and about 30 volume percent. Typically, the amount, size and PSD of the added beads 10 all may vary as a function of the character of the to-be-amended soil 15 (hardness, composition, dryness, and the like). The beads 10 may be added during any convenient process, such as while tilling, hoeing, or the like.

Although it is sometimes advantageous to use open pore glass beads 10 as soil amendment additives, this is not always the case. Closed pore beads 10 are advantageous when water percolation and/or aeration needs to be maximizad. The closed pore bead 10 provides a lighter, much less absorptive soil mix than open pore materials. Root distribution can thus be maximized as the root 20 cannot normally grow through the bead 10 and is diverted back into the soil mixture 30, 45. This can allow the root system 20 to spread across a greater volume than in denser soils.

### EXAMPLE 1

A first soil composition may be prepared by adding 20 volume percent closed pore glass beads 10 to a 1:1:1 volumetric mix of peat moss, coco peat and rice husks. The glass beads 10 are of a soda-lime-silica compositions and are characterized by a mean diameter of about 0.5 mm.

### EXAMPLE 2

A substantially homogeneous soil composition may be prepared by mixing 30 volume percent closed pore glass beads 10 having a mean diameter of 8 mm with a 2:3:2 volumetric mix of peat moss, coco peat and rice husks.

### EXAMPLE 3

A soil composition may be prepared by mixing 10 volume percent closed pore glass beads 10 into a 1:1 by volume mixture of peat moss and sand.

### EXAMPLE 4

A granular soil composition may be prepared by mixing first mixture of organic material and a second plurality of substantially nonporous generally spherical foamed glass particles, wherein the second mixture is present in amounts of between about 20 and 50 volume percent. The first mixture is typically selected from the group including bark, wood chips, rice husks, coco peat, peat moss and mixtures thereof and wherein the plurality if substantially nonporous generally spherical foamed glass particles are characterized by mean strengths of at least about 350 PSI, diameters of between about 0.1 and 10 millimeters, and bulk densities of between about 15 and about 60 lb/ft³.

The compositions in Examples 2 and 3 may vary by an up to 50 percent bead additive for maximum filtration. The composition of Example 3 may be varied by a 5-15 volume percent bead addition to a mixture 45 of peat moss 40 and sand 35 that may vary from 2:3 to 3:2 or more.

While the novel technology has been illustrated and described in detail in the drawings and foregoing description, the same is to be considered as illustrative and not restrictive in character, it being understood that only the preferred embodiment has been shown and described and that all changes and modifications that come within the spirit of the novel technology are desired to be protected.

We claim:

1. An artificial mixture, soil comprising:
a plurality of substantially closed pore glass spheres; and
a plurality of fine substance particles wherein the fine substance is selected from the group consisting of natural soils, natural sands, organic substances derived from living matter, charcoal powder, and ash.

2. A process for producing an artificial soil comprising:
foaming vitreous precursors to yield a plurality of substantially closed-pore generally spherical glass particles; and
mixing the plurality of substantially closed-pore generally spherical glass particles with a plurality of particles of fine substances selected from the group consisting of sand, perlite, pumice, vermiculite, organic substances derived from living matter, charcoal powder, and ash;
wherein the glass particles are characterized by an average compressive strength of at least about 350 PSI;
wherein the glass particles are characterized by a diameter of between about 0.1 and 10 millimeters.

3. An artificial soil as claimed in claim 2, wherein the organic substances derived from living matter are selected from the group consisting of leaves, bark, wood chips, rice husks, coco peat, peat moss and mixtures thereof.

4. The artificial soil as claimed in claim 2, wherein the foamed glass particles have a bulk density of from about 15 to about 60 lb/ft³.

5. The artificial soil as claimed in claim 2, wherein the foamed glass particles are characterized by an average compressive strength of at least about 950 PSI.

6. The artificial soil of claim 2 and further comprising a living plant growing therein.

7. A granular soil composition consisting essentially of a first mixture of organic material and a second plurality of substantially nonporous generally spherical foamed glass particles, wherein the second plurality of substantially nonporous generally spherical foamed glass particles is present in amounts of between about 20 and 50 volume percent, wherein the first mixture is selected from the group including bark, wood chips, rice husks, coco peat, peat moss and mixtures thereof and wherein the plurality if substantially nonporous generally spherical foamed glass particles are characterized by mean strengths of at least about 350 PSI, diameters of between about 0.1 and 10 millimeters, and bulk densities of between about 15 and about 60 lb/ft³.
